(19) United States
(12) Patent Application Publication
(10) Pub. No.: US 2007/0269767 A1
(43) Pub. Date: Nov. 22, 2007

(54) Adjustment screw for orthodontic adjustment devices

(76) Inventors: Winfried Schuetz, Munich (DE); Claus Schendell, Gilching (DE)

Correspondence Address: MILDE & HOFFBERG, LLP, 10 BANK STREET, SUITE 460, WHITE PLAINS, NY, 10606, US

(21) Appl. No.: 11/473,258

(22) Filed: Jun. 22, 2006

(30) Foreign Application Priority Data
May 5, 2006 (DE) 10 2006 021 107.3

(51) Int. Cl. A61C 8/00

(52) U.S. Cl. 433/174

(57) ABSTRACT

The adjustment screw (1) to lock the position and orientation of teeth along the jawbone includes a threaded nut (2) and a threaded spindle (3) transfixing it. The adjustment screw includes a recess (5) for a securing wire (6). To hold the securing wire in the recess a fixed locking mechanism (13) is provided next to the recess (5), into which is inserted a flat, U-shaped elastic clamp (16) with two free legs (17, 18). The locking mechanism (13, 13′) and the spring clamp (16) include corresponding engaging mechanisms (23, 24; 21, 22) to hold the inserted spring clamp (16) in position. In this position, the ends of the legs (17, 18) of the spring clamp (16) cover the recess (5) in order to hold the securing wire (6) in the recess (5).

### BACKGROUND OF THE INVENTION

The invention relates to an adjustment screw for orthodontic adjustment devices, particularly a tension screw or a pressure screw for adjusting the position and orientation of teeth along the jawbone.

One of the important tasks in jaw orthodontics is to adjust the positional relationships within the jaw, or on the jawbones, so that the teeth of the jawbone and the mandible are straight with respect to one another. A distinction is made between inadequate space and excessive space within the jawbone. It is therefore necessary in the case of inadequate space to create the space the teeth require for their proper position. For example, in the case of excessive space in the form of gaps, this excess must be treated by reducing tooth separation during orthodontics. In orthodontics, with increasing frequency inadequate space is handled with a firmly-attached adjustment device. For this, clamps, so-called brackets, are adhered to the teeth being treated, each of which possess a recess such as a slot into which curving or securing wire is inserted. In order to treat an excessive space or an inadequate space within a jawbone, an adjustment screw is inserted between matching points of the adjustment device that includes a threaded nut and a threaded spindle transfixing it. Forces are thus exerted on teeth, or groups of teeth, by means of a securing element, e.g., a ligature wire. Such forces may be adjusted by means of the adjustment screw so that the excessive space or inadequate space is removed during the course of treatment.

For example the configuration of an adjustment device with one or several adjustment screws is described, in German Patent No. DE 3,217,241 C2. In this known adjustment device, the adjustment screw is, for example, secured by means of a four-sided, securing wire that is inserted through a similarly-shaped so-called utility tube on the bracket, and secured by bending within the tube.

German Patent Document DE 20 100 765.7 describes a adjustment screw that includes a recess, in this case in the form of an essentially U-shaped slot, that may be forced directly onto the securing wire. Thus, one may do away with the supplemental tube, whereby the space requirement for the adjustment device is simultaneously reduced. A locking element is provided to hold the securing wire in the slot, by means of which the slot receiving the securing wire may be covered.

This locking element may, for example, be a locking bar that may pivot and engage, or a bow-shaped spring whose one leg is arrested in the adjustment screw, and whose bent second leg covers the slot directly.

### SUMMARY OF THE INVENTION

The principal object of the invention is to improve and refine an adjustment screw of this type. The adjustment screw must be of simple design and must enable positive arrestment of the securing wire. Also, the adjustment screw must be easy to produce.

This object, as well as other objects which will become apparent from the discussion that follows, are achieved, in accordance with the present invention by an adjustment screw which includes a threaded nut and a threaded spindle transfixing it. This adjustment screw includes a recess for a securing wire. To hold the securing wire in the recess a fixed locking mechanism is provided next to the recess, into which is inserted a flat, U-shaped elastic clamp with two free legs. The locking mechanism and the spring clamp include corresponding engaging mechanisms to hold the inserted spring clamp in position. In this position, the ends of the legs of the spring clamp cover the recess in order to hold the securing wire in the recess.

Accordingly, the adjustment screw possesses a fixed locking-bar arrangement with a striker element beside the recess, e.g., the slot. An essentially U-Shaped spring clamp is inserted into the locking mechanism within a guide, made, for example, of thin spring steel. The clamp possesses a U-shaped bow and two free legs, whereby the U-shaped bow receives the striker element in a fully inserted condition of the clamp. The locking mechanism and the legs of the clamp possess corresponding engaging mechanisms to hold the inserted clamp in this position. The ends of the free legs of the clamp are of such dimensions that they cover the recess and hold the securing wire in the recess when in the fully inserted condition.

According to an advantageous embodiment of the invention, a spar is provided extending longitudinally along at least one side of the recess whose one spar wall facing the recess flows into a sidewall of the recess. To guide the clamp, the spar possesses two slits transfixing the spar or the spar wall that extend perpendicular to the sidewall and are separated from each other by the striker element. The width and thickness of the slits in the spar are matched to the corresponding dimensions of the leg of the spring clamp. The two legs of the clamp are inserted through the two slits, whereby, in the final position of the clamp, the corresponding engaging mechanisms of the clamp and the locking mechanism engage with each other, holding the clamp in position. The ends of the free legs of the clamp then cover the recess and hold the securing wire in the recess.

According to another advantageous embodiment of the invention, the adjustment device possesses a single locking element that possesses an approximately mushroom-shaped longitudinal cross section, a head forming the striker element, and a rod bearing the engaging mechanisms. Two recesses are provided on the side of the rod facing the recess. The clamp legs include two matching lugs on their free ends that engage in the recesses of the locking element in fully inserted position. In this position, the clamp surrounds the locking element.

According to another advantageous embodiment of the invention, the adjustment device possesses two external locking strips extending essentially perpendicular to the recess for the securing wire and a striker element positioned between them. The corresponding engaging mechanisms of clamp and locking mechanism are positioned on the outer sides of the clamp legs and on the inner sides of the locking rods facing them.

According to another advantageous embodiment of the invention, second matching engaging mechanisms are provided between the clamp and the engaging mechanism by means of which extraction of the partially inserted clamp from the slits is prevented. Thus, the clamp is constantly connected with the locking mechanism even when it is not completely inserted into the locking mechanism. This prevents the clamp from being lost as a separate part.

According to another advantageous embodiment of the invention, the adjustment screw may also be provided with an additional securing medium, e.g., a screw stump or a threaded stud, by means of which they may be attached to an implantation screw in the jawbone.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a top view of a tension screw according to the invention.

FIG. 2 is a side view of the tension screw in FIG. 1.

FIG. 3 is a cutaway view through the tension screw along the section line III-III in FIG. 2 to show a locking mechanism with a single locking element and a view of the clamp that may be inserted into the tension screw.

FIGS. 4a and 4b are top views of the clamp and a profile view of the clamp, respectively.

FIG. 5 is a view, as in FIG. 3, with an alternative configuration of the locking mechanism and the clamp.

### DESCRIPTION OF THE PREFERRED EMBODIMENTS

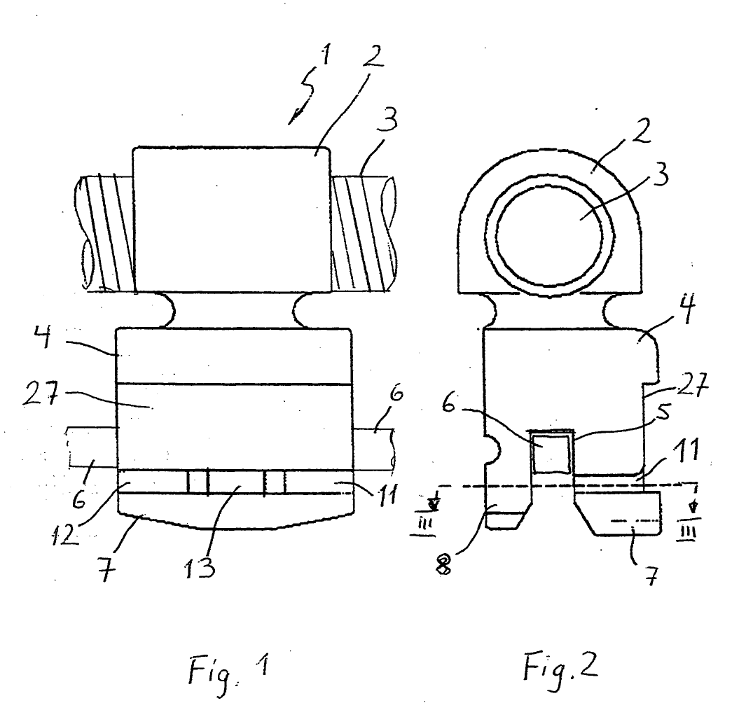

The preferred embodiments of the present invention will now be described with reference to FIGS. 1-5 of the drawings. Identical elements in the various figures are designated with the same reference numerals.

FIGS. 1 through 4b show a tension screw 1 that possesses a threaded nut 2 into which a threaded spindle 3 may be threaded. An extension 4 is affixed to the threaded nut 2 that possesses a slot of rectangular cross-section that may be forced directly onto the securing wire 6 (rectangular in this case) that is received within the slot 5. The slot and the securing wire may, naturally, possess other cross sections.

Two spars, namely a first spar 7 and a second spar 8, are provided on opposite sides of the slot 5 that flow into the two sidewalls of the slot 5. The first spar 7 is provided with two transfixing slits 11 and 12 that extend from the opposing ends of the spar 7, and are separated by a locking element 13 of mushroom-shaped cross section possessing a head 14 and a rod 15. The locking element 13 extends over the entire depth of the slits 11 and 12, and is preferably formed as one piece with the extension 4 and the first spar 7.

The slits 11 and 12 are perpendicular to the sidewalls of the slot 5, and end on the side opposite to the floor of the slot 5 immediately in the area of one side of a securing wire 6 inserted into the slot 5.

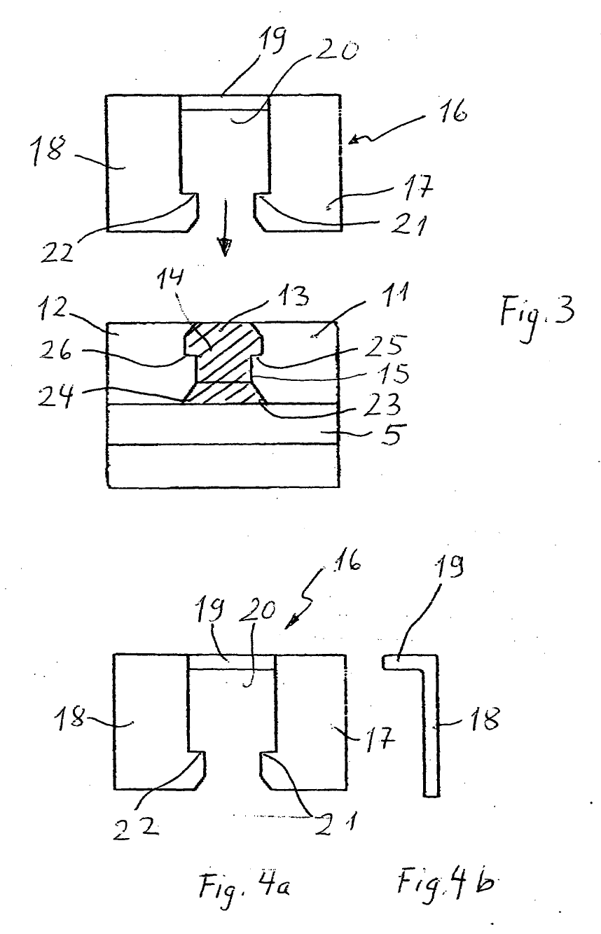

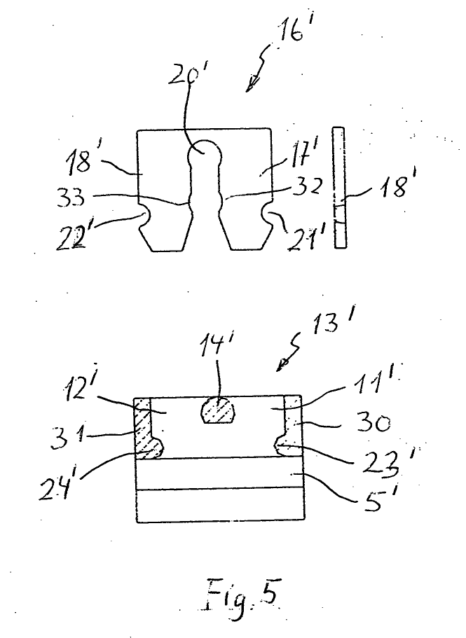

A clamp 16 of thin, elastic spring steel (shown in FIGS. 3 and 4a and 4b) is provided to lock the securing wire 6 in the slot 5. As the top view in FIG. 4a shows, the clamp possesses approximately a U-shape, with its one free leg 17 and a second leg 18 that are connected together by means of bent connector spar 19, so that, as FIG. 4b shows, an approximately L-shaped cross section results. The area between the legs 17 and 18 and the connector spar 19 may be designated as a U-shaped bow 20.

As FIG. 4a shows, the legs 17 and 18 are approximately rectangular, and possess projecting lugs 21 and 22 on their free ends facing each other. The two legs 17 and 18 of this clamp 16 are inserted into the slits 11 and 12, whereby, in inserted condition of the clamp 16 of the head 14 of the locking element 13 as a strike area for the clamp 16, and is received into its U-shaped bow. The legs 17 and 18 surround the mushroom-shaped locking element 13 in the completely inserted condition of the clamp 26. For this, the projecting lugs 21 and 22 rest against corresponding recesses 23 or 24 on the end of the rod so that they are held by the clamp 16. Because of the elasticity of the legs, the legs may spread the recesses, and the recesses snap into locked position. The legs 17 and 28 of the clamp are of such dimensions that their end areas completely cover the slot 5 in inserted position, thereby holding the securing wire in the slot 5. The ends of the legs 17 and 18 thereby rest against the inner wall of the second spar 8. A second small slot (not shown) may be provided that is cut into this second spar 8 into which the ends of the legs 17 and 18 engage, thus affixing the clamp 16 in its inserted position.

Second recesses 25 and 26 are provided on the locking element 13 and are positioned along the lower' edge of the head 14 of the locking element 13. If the clamp 16 is forced over the head 14, the projecting lugs 21 and 22 engage with these recesses 25 and 26 so that the clamp 16 is permanently held within the tension screw 1 so that it may not be lost.

Another recess 27 is provided on the outer side of the extension 4 into which the connector spar 19 is inserted when the clamp 16 is in inserted condition so that a smooth exterior surface of the tension screw results.

Although slits 11 and 12 in the extension 4 are described in the above to guide the legs 17 and 18 of the clamp 16, other options are conceivable. For example, the locking element 13 may possess a slot-type guide rail into which the inner edges of the legs 17 and 18 are inserted. Further, the length of the spar 7 may be reduced.

FIG. 5 shows a view of a locking mechanism 13′ and a clamp 16′ as in FIG. 3 for an additional embodiment example of the invention. The locking mechanism 13′ possesses a central striker element 14′ corresponding to the head 14 of the locking element 13 described above, as well as a locking strip 30 or 31 on the exterior side of each slit 11′ and 12′. The locking strips 30 and 31 each include a lug 23′ or 24′ projecting inward on their ends facing the slot 5′.

Again, a U-shaped clamp 16′ of flat, thin spring steel with two legs 17′ and 18′ and a U-shaped bow 20′ between them, whereby two recesses 21′ and 22′ corresponding to the projecting lugs 23′ and 24′ of the locking mechanism 13′ have been hollowed out. The legs of the clamp 16′ are inserted into the slits 11′ and 12′ of the locking mechanism 13′ until the corresponding projecting lugs 23′, 24′ of the locking mechanism engage with the recesses 21′, 22′, affixing the clamp 16′. In this position, the striker element 14′ is received into the U-shaped bow 20′, and the free ends of the legs 17′, 18′ completely cover the slot 5′.

Two recesses 32 or 33 are provided on the inner sides of the legs 17′, 18′ that surround the striker element 14′ when the clamp 16′ has not yet been fully inserted, holding the clamp within the adjustment screw so that it may not be lost.

Although the above describes how the adjustment screw may be affixed directly onto the securing wire, it is possible to affix the adjustment screw into an implantation screw directly in the jawbone with the help of an affixing medium, e.g., a threaded socket, threaded stud, or similar. The design of the adjustment screw remains unaltered. It may further receive the securing wire, but is fixed in its position in the jawbone.

There has thus been shown and described a novel adjustment screw for orthodontic adjustment devices which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In an adjustment screw for orthodontic adjustment devices, particularly a tension screw or pressure screw, to adjust the position and orientation of teeth along the jawbone, wherein the orthodontic adjustment device possesses a securing wire extending along the jawbone, and the adjustment screw possesses a threaded nut and a threaded spindle transfixing it interacts within the adjustment device between two teeth or groups of teeth, wherein the adjustment screw possesses a recess that may be forced directly onto the securing wire, and wherein a locking mechanism is provided by means of which the recess containing the securing wire may be covered, the improvement wherein:
the adjustment screw possesses a fixed locking mechanism positioned along the recess with a striker element;
a flat, essentially U-shaped elastic spring with a U-shaped bow is provided that may be inserted into the locking mechanism in a guide, forming a clamp with two legs, whereby in fully inserted position of the clamp, its legs receive the striker element of the locking mechanism;
the locking mechanism and the legs of the clamp possess corresponding engaging mechanisms in order to hold the inserted clamp in place; and
the ends of the legs of the clamp are of such dimensions that they cover the recess when in a completely inserted position in order to hold the securing wire in the recess.

2. Adjustment screw as in claim 1, further comprising a spar that extends longitudinally along at least one side of the recess, said spar having two slits completely transfixing it which extend perpendicular to the sidewall of the recess, and are separated from each other by the striker element, whereby the legs of the clamp may be inserted into the slits.

3. Adjustment screw as in claim 2, wherein the spar wall facing the recess flows into a sidewall of the recess.

4. Adjustment screw as in claim 1, wherein the locking mechanism includes a single locking element having an approximately mushroom-shaped longitudinal cross section in a top view of the recess with a head forming the striker element and an adjacent rod pointed toward the recess that includes two recesses on its side facing the recess, and wherein the legs of the clamp include two protruding lugs on their free ends that engage with the recesses of the locking element.

5. Adjustment screw as in claim 1, wherein the locking mechanism includes two locking strips extending essentially perpendicular to the recess and a striker element positioned centrally between the locking strips, and wherein the engaging mechanisms of the clamp and of the locking mechanism are positioned along the outer sides of the legs of the clamp and on the inner sides of the locking strips facing them.

6. Adjustment screw as in claim 1, wherein the locking mechanism and the clamp include additional matching engaging mechanisms that hold the clamp in a position not completely inserted in order to connect the clamp to the adjustment screw.

7. Adjustment screw as in claim 1, wherein the clamp include an L-shaped cross section, whereby the two legs of the clamp are connected together by means of a bent connector spar.

8. Adjustment screw as in claim 7, further comprising a recess is on the outer side of the adjustment screw into which the bent connector spar (19) is inserted when the clamp (16) is in inserted position.

9. Adjustment screw as in claim 1, wherein the clamp is made of spring steel.

10. Adjustment screw as in claim 1, wherein the recess for the securing wire is a slot with approximately a U-shaped cross section.

11. Adjustment screw as in claim 1, wherein the adjustment screw includes a securing medium by means of which it may be attached to an implantation screw to transfer force directly to the jawbone.
